(19) United States
(12) Patent Application Publication
(10) Pub. No.: US 2015/0224521 A1
(43) Pub. Date: Aug. 13, 2015

(54) CONTROLLED DROPLET APPLICATION WITH DIRECTIONAL SHROUD FOR LIMITING APPLICATION AREA

(71) Applicants: John PETERSON, Jackson, MN (US); Justin BAK, Windom, MN (US); AGCO CORPORATION, Duluth, GA (US)

(72) Inventors: John Peterson, Jackson, MN (US); Justin Bak, Windom, MN (US)

(73) Assignee: AGCO Corporation, Duluth, GA (US)

(21) Appl. No.: 14/432,332

(22) PCT Filed: Sep. 24, 2013
(86) PCT No.: PCT/US13/61349

§ 371 Date: Mar. 30, 2015

Related U.S. Application Data
(60) Provisional application No. 61/707,234, filed on Sep. 28, 2012.

(51) Int. Cl. B05B 3/08; B05B 15/04; B05B 3/10

(52) U.S. Cl. CPC B05B 3/085; B05B 3/1014; B05B 15/0437

(57) ABSTRACT

A controlled droplet application (CDA) nozzle has a cone having plural ridges disposed longitudinally on an interior surface of the cone. The cone has a circumferential lip having grooves defined by the plural ridges, and a directional shroud having one or more arcs disposed on the surface of the shroud that cover all but a portion of the lip.

### CROSS REFERENCE TO RELATED APPLICATION

This application claims the benefit of U.S. Provisional Application No. 61/707,234, filed Sep. 28, 2012, which is hereby incorporated by reference in its entirety.

### TECHNICAL FIELD

The present disclosure is generally related to spraying technology, and, more particularly, to controlled droplet applications.

### BACKGROUND

A controlled droplet application (CDA) nozzle operates on a completely different principle than conventional hydraulic nozzles. CDA nozzles deposit liquid fluid to be applied on the inside of a spinning cone. The inside of the cone may be lined with ridges traveling from the narrow end of the cone to the wide end. These ridges help impart rotational energy to the fluid spinning it faster. The ends of the ridges are used to shear the flowing liquid fluid into droplets. As the CDA cone spins faster, the smaller droplets get sheared and released from the end of the ridges, which enables the spectrum of droplet sizes to be controlled by adjusting the speed of the CDA cone.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a schematic diagram generally depicting an embodiment of an example controlled droplet application (CDA) system with a CDA nozzle in horizontal orientation and covered in part by a directional shroud.

FIG. 1B is a schematic diagram showing select features in cut-away view of the example CDA system shown in FIG. 1A.

FIG. 1C is a schematic diagram showing certain features in exploded view of the example CDA system shown in FIG. 1A.

FIG. 1D is a schematic diagram of an embodiment of an example CDA nozzle cone in a perspective view showing a portion of an interior of the CDA nozzle cone.

FIG. 2 is a schematic diagram that illustrates, in a top plan view, an example, directional spray pattern provided by an example CDA system.

FIG. 3 is a schematic diagram of an embodiment of an example CDA nozzle having a directional shroud that covers all but a portion of a circumferential lip of a cone of the CDA nozzle.

FIG. 4A is a schematic diagram of an embodiment of an example directional shroud having a single arc on the surface used to block a single arc portion of a circular spray pattern dispersed from a circumferential lip of a CDA nozzle cone.

FIG. 4B is a schematic diagram that illustrates an example configuration of the single arc depicted in FIG. 4A.

FIG. 5 is a schematic diagram of an embodiment of an example directional shroud having plural arcs on the surface used to block plural, discontiguous arc portions of a circular spray pattern dispersed from a circumferential lip of a CDA nozzle cone.

FIG. 6 is a flow diagram of an embodiment of an example CDA method.

### DESCRIPTION OF EXAMPLE EMBODIMENTS

### Overview

In one embodiment, a controlled droplet application (CDA) nozzle comprising a cone having plural ridges disposed longitudinally on an interior surface of the cone, the cone comprising a circumferential lip comprising grooves defined by the plural ridges; and a directional shroud having one or more arcs disposed on the surface of the shroud that cover all but a portion of the lip.

### Detailed Description

Certain embodiments of a controlled droplet application (CDA) system and method are disclosed that enable a CDA nozzle to control the direction of uniformly sized droplets characteristically produced by CDA-type nozzles. In one embodiment, the CDA system comprises a CDA nozzle cone that is placed within a directional shroud that limits the direction in which the droplets can travel. The CDA nozzle cone may be configured in the horizontal orientation (e.g., with the center axis of the cone coincident with the horizontal axis), or any other orientation, for precise control of the direction of the applied fluid spray to the intended target. For instance, the directional shroud may be configured to limit the droplet dispersion area to only the bottom 90 degrees of the CDA nozzle cone. Such a configuration results in the directional shroud collecting the droplets from the 270 degrees to the right, above, and to the left of a horizontally oriented CDA nozzle. In other words, the CDA system enables directional control over the spray.

Conventional CDA system designs also produce droplets of uniform size with a lower liquid fluid input than hydraulic nozzles. By producing droplets of uniform size, the volume of liquid fluid wasted in ineffective droplet sizes may be minimized. However, current CDA systems lack the ability to direct the spray pattern to anywhere but the vertical or near vertical orientation. For instance, conventional CDA nozzle cones are spun in a vertical or near vertical orientation (e.g., within ten (10) degrees of the vertical axis) to provide a circular pattern, possibly wasting liquid fluid (hereinafter, the latter referred to merely as fluid) where the application of the spray is not needed. In contrast, CDA systems of the present disclosure may operate with the cone oriented in the horizontal or any other direction, and with the directional shroud, provides more precise control of the direction of the applied fluid spray, with less waste since areas unintended for fluid treatment are blocked from spray application by the directional shroud.

Having summarized certain features of CDA systems of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, the focus is on a horizontal orientation of the CDA nozzle (including cone), with the understanding that vertical or other orientations may be achieved in certain embodiments. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

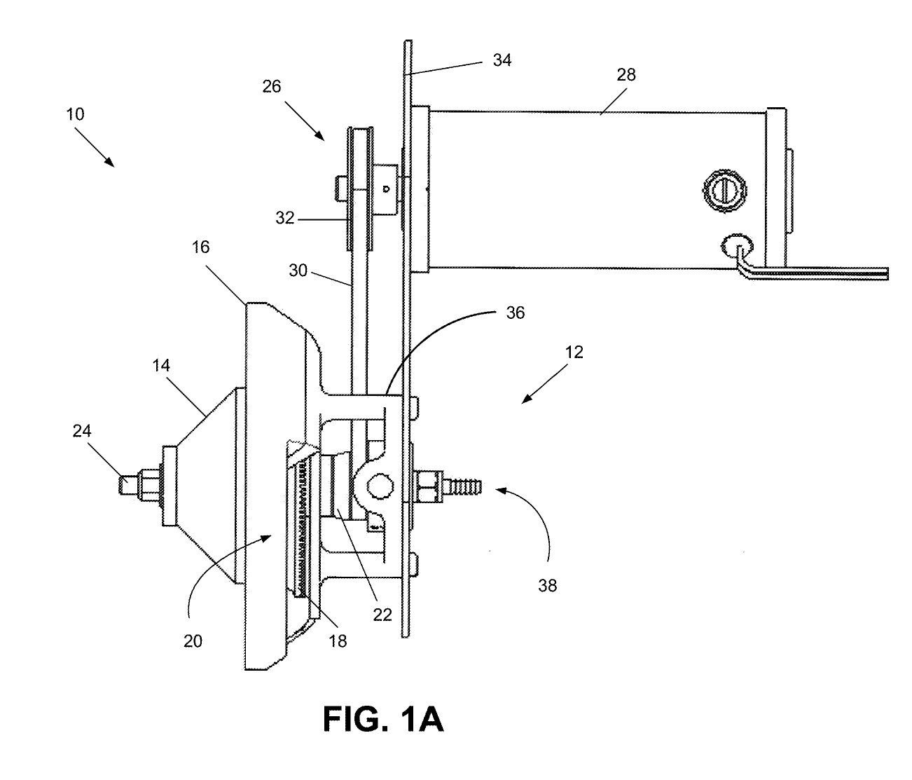

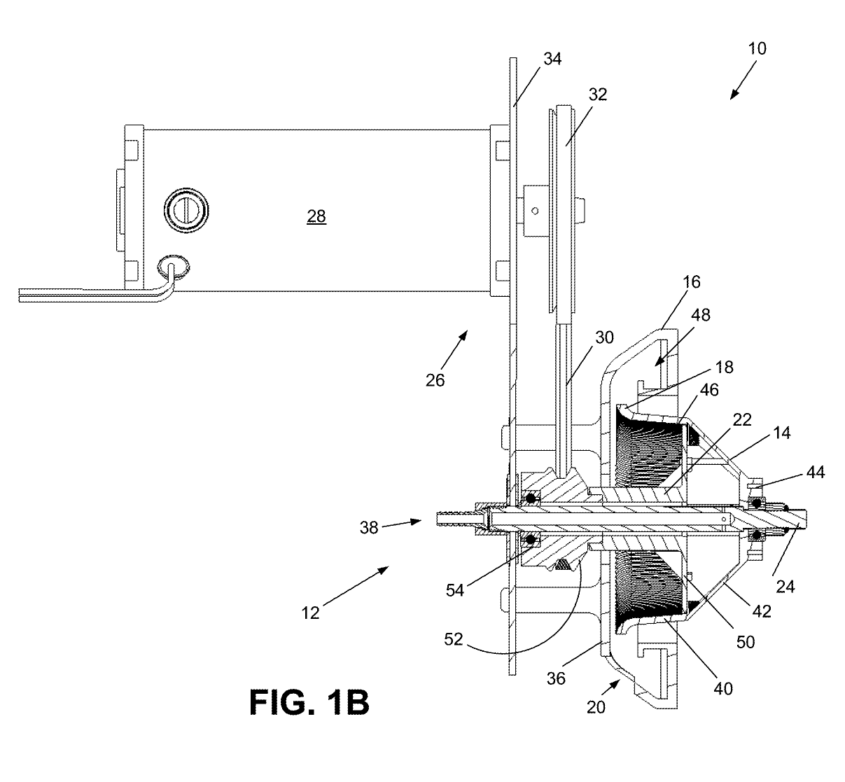

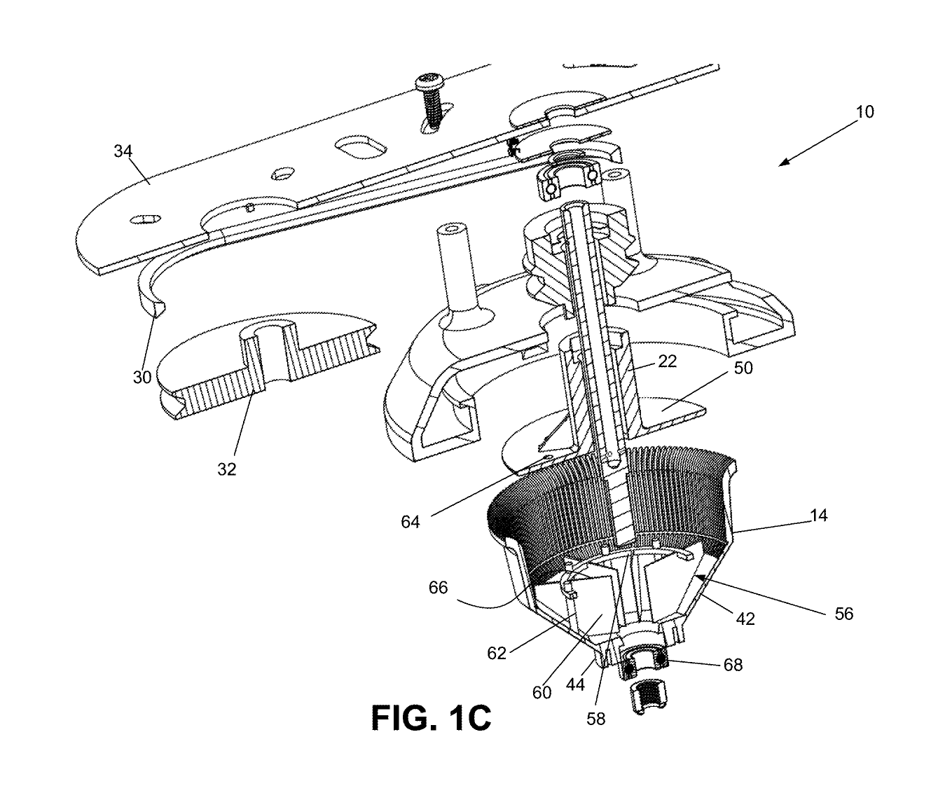

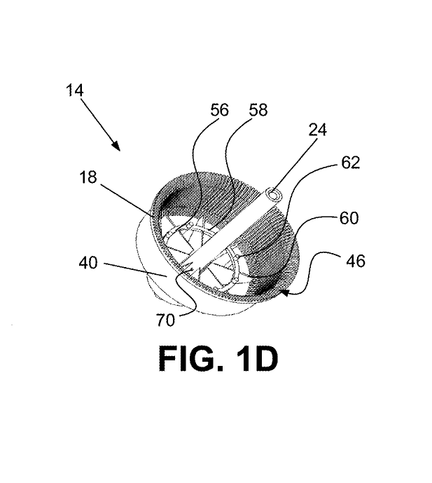

FIGS. 1A-1D depict several illustrations of an embodiment of a CDA system 10, with each illustration focusing on select features of the system. One having ordinary skill in the art should appreciate in the context of the present disclosure that the CDA system 10 shown in, and described in association with, FIGS. 1A-1D, is merely illustrative, and that other system arrangements with fewer or additional components are contemplated to be within the scope of the disclosure. As is evident by comparison among FIGS. 1A-1D, certain features are omitted in each figure to emphasize the features shown in a particular figure. Referring now to FIG. 1A, shown is an embodiment of an example CDA system 10. The CDA system 10 may be used in an agricultural environment, such as to spray fluids (e.g., chemicals) on crops, bare ground, etc., as pre-emergence and/or post-emergence herbicides, fungicides, and insecticides. The CDA system 10 may be secured to a tractor frame, boom, among other agricultural equipment similar to implementations for conventional CDA nozzles. Further, a given boom may have a plurality of CDA systems 10 arranged along the boom. In some embodiments, the CDA system 10 may be used in other environments, such as those requiring the application of other types of fluids to other surfaces. The CDA system 10 exhibits some of the well-known characteristics of conventional CDA nozzles, including the provision of a substantially uniform size fluid droplet based on low flow inputs.

The CDA system 10 comprises a CDA nozzle 12 that is depicted in FIG. 1A in the horizontal orientation, though any orientation may be used. The CDA nozzle 12 comprises a cone 14 and a directional shroud 16 that covers at least a portion of the fluid-discharge end of the cone 14. For instance, in one embodiment, the cone 14 comprises a circumferential, outward-directed lip 18 from which the substantially uniform size fluid droplets are dispensed in a circular flow pattern. The directional shroud 16 blocks all but a portion of the dispensed fluid, such as a portion that passes the directional shroud 16 through an aperture 20 of the directional shroud. As is described below, the aperture 20 is defined by a single arc (or a plurality of arcs in some embodiments) located on the surface of the directional shroud 16. The CDA nozzle 12 also comprises a shaft 22 that runs longitudinally through at least a portion of the cone 14. Disposed concentrically within the shaft 22 is at least a portion of a hollow spindle 24 that introduces fluid into the cone 14 through holes in the spindle 24. The shaft 22 is coupled to the cone 14 and is engaged by a drive system 26 to cause rotation of the cone 14 relative to the stationary spindle 24. The cone 14 rotates to produce droplets from an inputted fluid stream. In one embodiment, the drive system 26 comprises a rotational actuator 28 and a pulley 30. The pulley 30 engages a wheel 32 of the rotational actuator 28 and also engages the shaft 22 of the nozzle 12 to cause rotation of the cone 14. The drive system 26 and the nozzle 12 are mounted to a frame 34, the nozzle 12 mounted to the frame 34 at least in part by a mounting assembly 36 of the directional shroud 16. The frame 34 may be connected (e.g., in adjustable or fixed manner) to a boom of a self-propelled agricultural machine (e.g., sprayer machine) or to a towed implement. In one embodiment, the frame 34 rigidly secures the aforementioned components with respect to each other. The mounting assembly 36 also, as the name implies, secures the shroud 16 to the frame 34. An input end 38 extending beyond the frame 34 and a nut at the opposite end of the spindle 24 compress the frame 34, the pulley 30, shaft 22, and the cone 14 together. The shroud 16 is mounted independently onto the frame 34, as noted above, and around the rotating sub-assembly (e.g., pulley 30, shaft 22, and cone 14), and hence the rotating sub-assembly rotates approximately in the middle of the shroud 16.

Fluid is provided to the input 38 of the spindle 24. The fluid may be provided through a flow control apparatus or system, as is known in the art. For instance, a flow control system may meter a defined volume of fluid into the spindle 24.

In one example operation, the rotational actuator 28 of the drive system 26 provides rotational motion to rotate the cone 14. In other words, the pulley 30 transfers the rotational motion of the rotational actuator 28 to the shaft 22, which through coupling between the shaft 22 and the cone 14, causes the cone 14 to rotate. The shaft 22 rotates around the hollow and stationary spindle 24. In one embodiment, an even flow of fluid is injected by a flow control system into the input 38. The fluid flows through the hollow spindle 24 and is discharged via openings in the spindle 24 into the interior space of the cone 14. In one embodiment, fins of a fin assembly located internal to the cone 14 divide and compartmentalize the liquid fluid evenly inside the cone 14 and ensure that the cone 14 produces an even distribution of uniformly-sized droplets. In some embodiments, the fin assembly may be omitted.

It should be appreciated within the context of the present disclosure that variations of the aforementioned CDA system 10 are contemplated and considered to be within the scope of the disclosure. For instance, in some embodiments, the drive system 26 may include a belt, gears, chain, hydraulic motor, pneumatic motor, etc. In some embodiments, the depicted drive system 26 may be omitted in favor of drive system that includes a direct coupling between a motor and the cone 14. In some embodiments, additional structure and/or components may be included, such as a precise speed control of the cone 14, a fan to assist droplet travel and penetration (e.g., into foliage), among other structures. Although not limited to a specific performance, some example performance metrics of the CDA system 10 may include a minimum flow rate of approximately 0.05 gallons per minute (GPM), a maximum flow rate of approximately 0.3 GPM, a minimum cone speed of approximately 2500 RPM, and a maximum cone speed of approximately 5000 PRM. These metrics are merely illustrative, and some embodiments may have greater or lower values.

Attention is now directed to FIG. 1B, which provides a cutaway view of certain features of the CDA system 10 shown in FIG. 1A. Recapping from the description above, the CDA system 10 comprises the CDA nozzle 12. The CDA nozzle 12 comprises the cone 14, the directional shroud 16, the shaft 22, and the spindle 24. In one embodiment, the cone 14 comprises a geometrical configuration that includes the circumferential lip 18 from which droplets are dispersed to a target according to a circular spray pattern. In one embodiment, the lip 18 is directed outward from the central axis of the cone 14. In some embodiments, the lip 18 is not directed outward relative to the central axis of the cone 14. The cone 14 also comprises a wide portion 40 and a narrow portion 42 that includes a base 44. The narrow portion 42 includes a diameter that decreases from the wide portion 40 to the base 44. In some embodiments, within the cone 14 corresponding to an interior surface of the narrow portion 42 is a fin assembly, as described further below. The interior surface of the cone 14 corresponding to the lip 18 and the wide portion 40 (and partially the narrow portion 42) comprises a plurality of longitudinal ridges 46, each pair of ridges 46 defining grooves therebetween to channel the fluid as the cone 14 rotates to provide a circular flow pattern of droplets released at the lip 18. In other words, the uniform droplets are dispersed from grooves (the grooves formed by plural ridges 46 in the interior surface of the cone 14, the ridges breaking off the droplets as the fluid flows from the grooves) at the lip 18 in circular fashion. All but a portion of the dispersed fluid is blocked by the directional shroud 16. The unblocked fluid dispersed from the lip 18 passes the directional shroud 16 via the aperture 20 and hence is directed to a target, such as the ground or foliage (e.g., crops, weeds, etc.). The blocked fluid is captured and routed by an internal channel 48 created by the directional shroud 16 and fed to a fluid reclamation system.

The nozzle 12 further comprises the shaft 22, which extends into and is coupled to the cone 14. The shaft 22 surrounds (e.g., concentrically) at least a portion of the hollow spindle 24. The hollow spindle 24 receives fluid (e.g., from a flow control system) at the input 38 and dispenses the fluid into the interior of the cone 14 corresponding to the narrow portion 42 (e.g., proximal to the base 44). Introduced in FIG. 1B is a circular cap 50 that segments the interior of the cone 14 in a plane proximal to the transition between the wide portion 40 and the narrow portion 42. In one embodiment, the cap 50 is integrated (e.g., molded, cast, etc.) with the shaft 22. In some embodiments, the cap 50 is coupled to the shaft 22 according to other known fastening mechanisms, such as via welding, riveting, screws, etc. In one embodiment, the cap 50 is also mounted to a fin assembly as described further below, although in some embodiments, the fin assembly may be omitted and the shaft 22 coupled to the cone 14 according to other fastening mechanisms. For purposes of brevity, the remainder of the disclosure contemplates the use of a fin assembly, with the understanding that the fin assembly may be omitted in some embodiments. The shaft 22 further comprises a hexagonal key portion 52 and bearing assembly 54 disposed between the frame 34 and the cone 14. The key portion 52 provides an area of engagement for the pulley 30 of the drive system 26, at the nozzle 12, the other area of engagement at the wheel 32 associated with the rotational actuator 28 of the drive system 26. The bearing assembly 54 (along with a bearing assembly on an opposing end of the spindle 24, as described below) enables the spindle 24 to guide the rotation of the shaft 22 and cone 14 relative to the stationary spindle 24, as driven by the drive system 26.

Also depicted in FIG. 1B, the directional shroud 16 mounts to the frame 34 via the mounting assembly 36. The mounting assembly 26, as the name implies, secures the shroud 16 to the frame 34. The input end 38 extending beyond the frame 34 and a nut at the opposite end of the spindle 24 compress the frame 34, the pulley 30, shaft 22, and the cone 14 together. The shroud 16 is mounted independently onto the frame 34, as noted above, and around the rotating sub-assembly (e.g., pulley 30, shaft 22, and cone 14), and hence the rotating sub-assembly rotates approximately in the middle of the shroud 16. In some embodiments, the directional shroud 16 may be detachable from, yet coupled to, the portion (mounting assembly 36) that mounts to the frame 34. The directional shroud 16 may be adjusted to enable the cone 14 to disperse the fluid in a fully circular spray of fluid or positioned to enable a truncated spray pattern. For instance, the directional shroud 16 may be offset from the outlet (e.g., lip 18) of the cone 14 (e.g., lifted closer to the frame 34) to avoid interfering with the discharge of the fluid droplets and hence enable a fully circular spray pattern of uniform droplets from the lip 18. In some embodiments, the directional shroud 16 may be positioned to block all but a portion of the circular spray pattern of the dispersed fluid, enabling a truncated spray pattern (e.g., in the form of a single arc spray pattern or plural arc spray patterns). The positioning of the directional shroud 16 may be achieved through manual adjustment, or in some embodiments, automatically (e.g., as controlled by a stepper motor or driven gear assembly coupled to the frame 34).

Referring to FIG. 1C, an exploded view of certain features of the CDA system 10 of FIGS. 1A-1B is shown. The frame 34, wheel 32, pulley 30, and shaft 22 have already been described in association with FIGS. 1A-1 B, and hence further discussion of the same is omitted here for brevity except where noted below. Of particular focus for purposes FIG. 1C is a fin assembly 56, which includes a ring 58, a plurality of fins 60 coupled to or integrated with the ring 58, and a plurality of pins 62 disposed between each pair of fins 60. The fin assembly 56 depicted in FIG. 1C is one example configuration, and it should be appreciated that other configurations of the fin assembly (e.g., with a fewer or greater number of pins 62 or fins 60) are contemplated to be within the scope of the disclosure. The fin assembly 56 is connected to the interior surface of the cone 14 corresponding to the narrow portion 42, and in particular, connected via the pins 62. Further, the cap 50 of the shaft 22 mounts to the fin assembly 56 via the pins 62 and the cap holes 64 of the cap 50. The cap 50 rests on an edge 66 of each fin 60 of the fin assembly 56. A bearing assembly 68 is located proximal to the base 44 as described above.

Turning attention now to FIG. 1D, shown in perspective is a portion of the interior of one embodiment of the cone 14 (with some features omitted for purposes of discussion, such as the cap 50). It should be appreciated within the context of the present disclosure that variations in the depicted structure are contemplated for certain embodiments, such as fewer or additional fins, and/or the extension (or reduction) of the quantity of ridges 46 along a greater (or lesser) area of the interior surface of the cone 14. As depicted in FIG. 1D, the cone 14 comprises the hollow spindle 24. The spindle 24 comprises one or more holes 70 proximal to the base 44 (FIGS. 1A-1C) that discharges the fluid in the shaft space into the interior of the cone proximal to the base 44. The cone 14 further comprises the longitudinal, discontiguous ridges 46 disposed on at least a portion of the interior surface (e.g., corresponding to the lip 18, wide portion 40, and a part (e.g., less than the entirety) of the narrow portion 42 (FIGS. 1A-1C). In some embodiments, the ridges 46 may occupy a larger amount of the interior surface, or a smaller part in some embodiments, or be contiguous throughout the interior surface of cone 14. Between the ridges 46 are grooves which enable the channeling of fluid injected from the spindle 24 to dispersion as droplets beyond the lip 18.

The interior of the cone 14 further comprises the fin assembly 56, as described above in association with FIG. 1C. In one embodiment, the fin assembly 56 is disposed in an interior space adjacent the narrow portion 42 (e.g., the narrow portion 42 having a decreasing diameter from the wide portion 40 to the base 44 (FIGS. 1A-1C). As described above, the fin assembly 56 comprises the ring 58 that, in one embodiment, encircles a central or center region of the cone 14 occupied by the shaft 22 and spindle 24. In one embodiment, a central axis of the ring 58 is coincident with a central axis of the spindle 24. The ring 58 is integrated with (e.g., casted or molded, or in some embodiments, affixed to) the plurality of the fins 60. The fins 60 extend from a location longitudinally adjacent the spindle 24 to the interior surface of the cone 14. In one embodiment, one or more edges of each fin 60 is flush (e.g., entirely, or a portion thereof) with the interior surface of the cone 14. In some embodiments, one or more edges of each fin 60 is connected (e.g., along the entire edge or a portion thereof in some embodiments) to the interior surface of the cone 14. In some embodiments, a small gap is disposed between one or more edges of each fin 60 (or a predetermined number less than all of the fins 60) and the interior surface closest to the fin 60. In some embodiments, the fins 60 may be affixed to the ring 58 by known fastening mechanisms (e.g., welds, adhesion, etc.) or integrations (e.g., molded, cast, etc.). The ring 58 further comprises the plural pins 62 that enable the mounting of the cap 50 (FIG. 1C) of the shaft 22 (FIG. 1) to the fin assembly 56, which also enables the shaft 22 to cause the rotation of the cone 14. The pins 62 also secure the fin assembly 56 to the interior surface of the narrow portion 42.

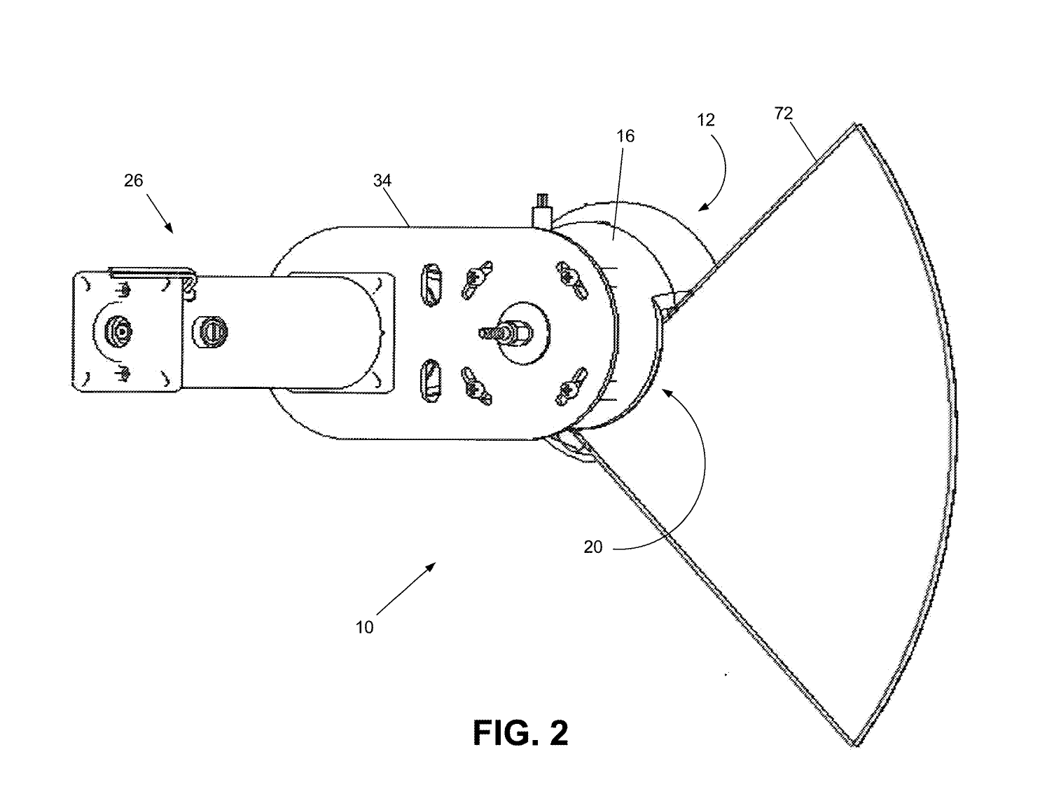

Referring now to FIG. 2, shown is a schematic diagram that illustrates, in a top plan view, an example, directional spray pattern provided by the example CDA system 10. It should be appreciated within the context of the present disclosure that the illustrated spray pattern is merely one example among numerous possible spray patterns that may be achieved depending on the configuration of the directional shroud 10 and/or the orientation of the axis of rotation of the cone 14. The frame 34 supports the nozzle 12, and as the cone 14 (FIGS. 1A-1D) rotates based on operation of the drive system 26, the circular spray pattern dispersed from the lip 18 (FIGS. 1A-1D) of the cone 14 is truncated by the directional shroud 16, resulting in the arc-shaped spray pattern 72 dispersed via the aperture 20 created in the directional shroud 16. The arc-shaped spray pattern 72 may be created from a single arc configuration on the surface of the directional shroud 16, or by plural adjacent or overlapping arc configurations on the surface of the directional shroud 16 in some embodiments. The portion of the fluid dispersed from the cone 14 and blocked by the directional shroud 16 is collected by the directional shroud 16 and redirected via a drain to a reservoir.

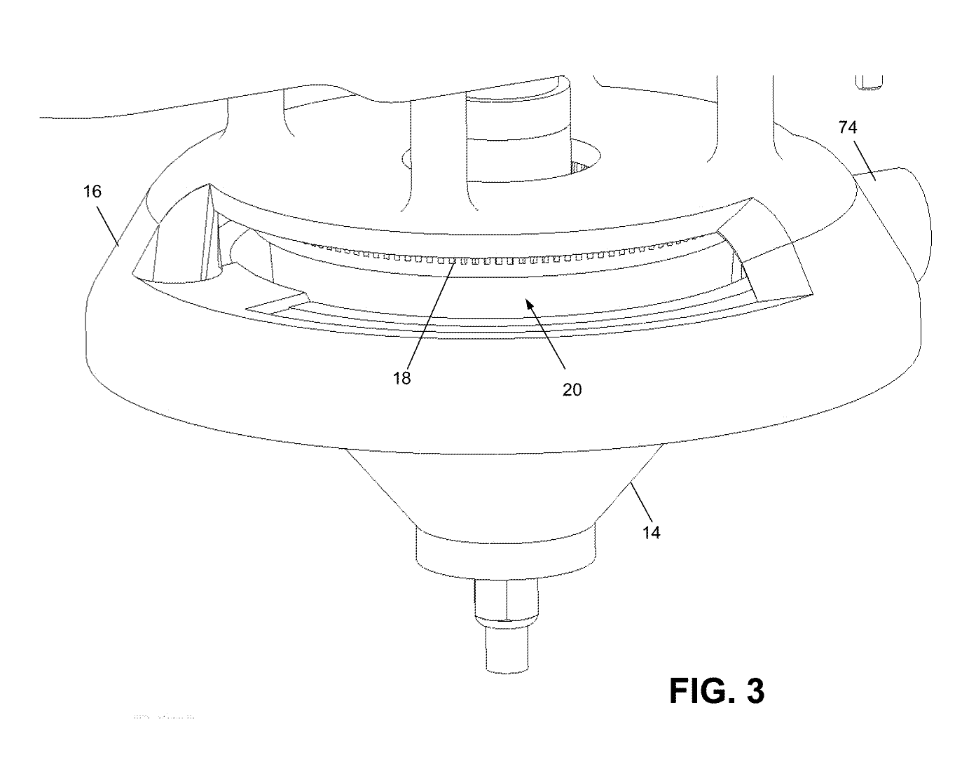

FIG. 3 provides a close-up schematic of the directional shroud 16 of the CDA system 10. As depicted in FIG. 3, the directional shroud 16 covers all but a portion of the cone 14, and in particular, all but a portion of the lip 18 of the cone 14. The directional shroud 16 has a saucer-like shape, and comprises the aperture 20 that enables the fluid dispersed from the lip 18 to pass through the directional shroud 16. The balance of the fluid dispersed from the lip 18 is blocked by the arc portion(s) of the directional shroud 16, and channeled to a drain 74 to be recovered at a reservoir of the fluid or other reservoir. The truncated fluid spray dispersed from the aperture 20 is directed out of the paper (FIG. 3) in an arc-like pattern, similar to that shown in FIG. 2.

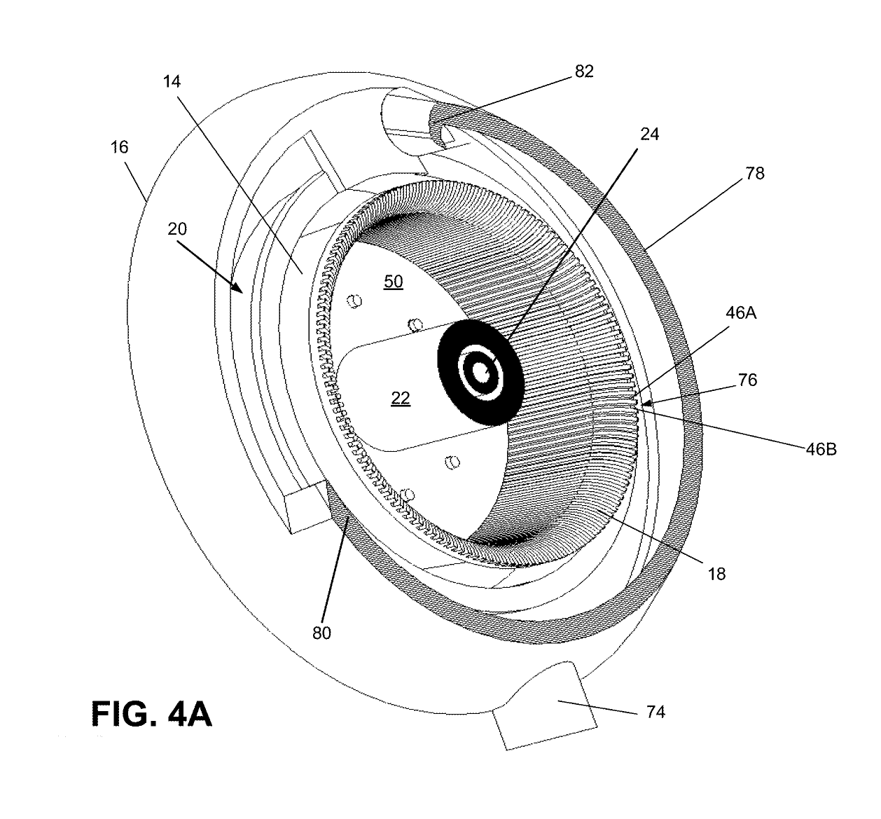

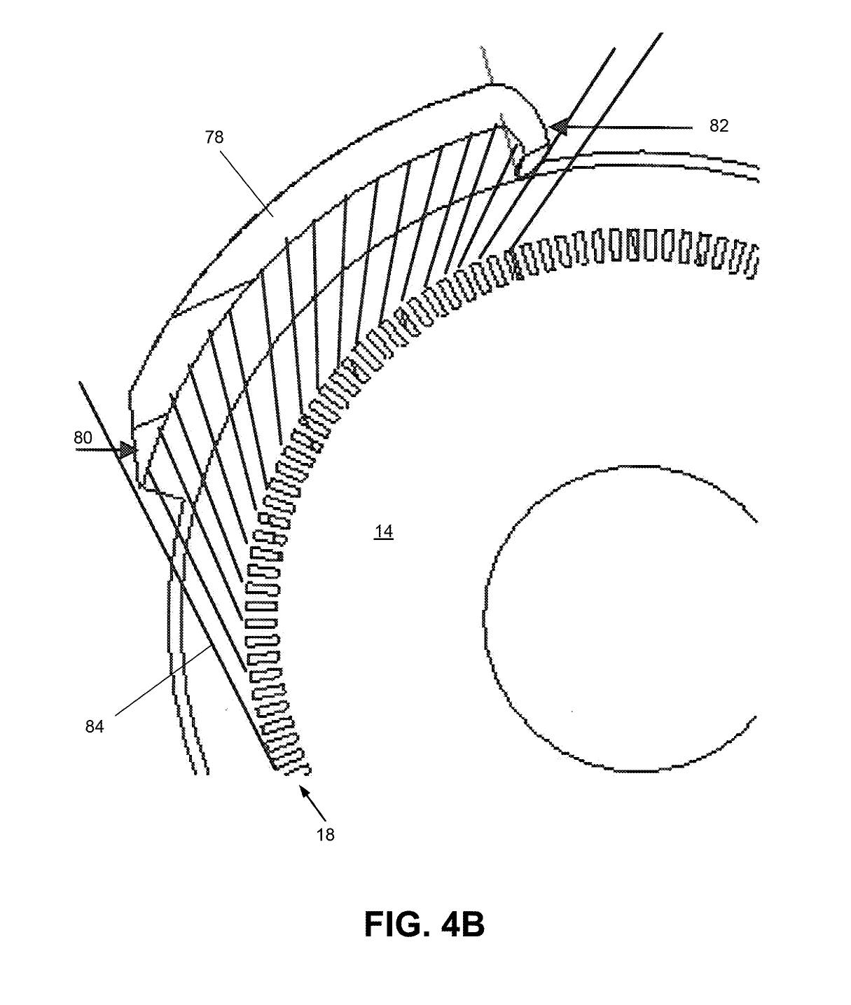

Referring to FIG. 4A, shown is a schematic diagram showing, from the perspective of the lip 18 and looking above the lip into the interior of the cone 14, an embodiment of an example directional shroud 16 having a single arc on the surface used to block a single arc portion of a circular spray pattern dispersed from a circumferential lip 18 of the nozzle 12 (FIGS. 1A-1D). It should be appreciated within the context of the present disclosure that the configuration of the directional shroud 16 shown in FIG. 4A is one among many possible configurations. The directional shroud 16 covers all but a portion (i.e., corresponding to the aperture 20) of the lip 18 of the cone 14. The shaft 22 is shown surrounding in concentric manner the spindle 24, where one end of the spindle 24 is obscured by the surface of the cap 50 that is disposed in the interior of the cone 14 and integrated with, or coupled to, the shaft 22. Grooves are shown more clearly in FIG. 4A, such as groove 76 defined between adjacent ridges 46A and 46B. The grooves 76 channel the fluid within the interior of the cone 14 and are broken into uniform size droplets at the lip 18 by the ridges 46. Also shown in FIG. 4A is an arc 78 on the surface of the directional shroud 16, the arc extending radially from approximately, using a clock analogy, the one o'clock position to the eight o'clock position when viewed in perspective. Other radial lengths of the arc 78 are contemplated to be within the scope of the disclosure. The arc 78 comprises a surface that radially covers the lip 18, except at the aperture 20. Functionally, the arc 78 enables the directional shroud 16 to block at least partially the circular spray dispersed at the lip 18, enabling a portion of the spray (e.g., a truncated portion of the circular spray) to pass through the aperture 20 and be applied to the target. The blocked portion is channeled through the drain 74 as described above.

The arc 78 comprises a leading edge 80 and a trailing edge 82, two edges which cut into the spray of the droplets. Referring now to FIG. 4B, shown is a portion of the droplets, represented by lines 84, dispersed from the lip 18 of the cone 14. It should be appreciated that the entire circular spray is dispersed from the cone 14, but only a portion is depicted here. The leading edge 80 of the arc 78 of the directional shroud 16 comprises a sharp geometric configuration that cuts into the spray to reduce the transition area that may include an intermediate number of droplets. The trailing edge 82 of the directional shroud 16 has a hooked-configuration (e.g., the hook directed inward toward the center of the cone 14) to direct the fluid back around towards the bottom (e.g., when in vertical orientation) of the directional shroud 16, enabling the blocked fluid to be channeled to a reservoir.

Note that some embodiments may omit the hooked configuration of the trailing edge 82, or have a different configuration (e.g., “L” shaped, etc.) to direct fluid back to the bottom of the directional shroud 16.

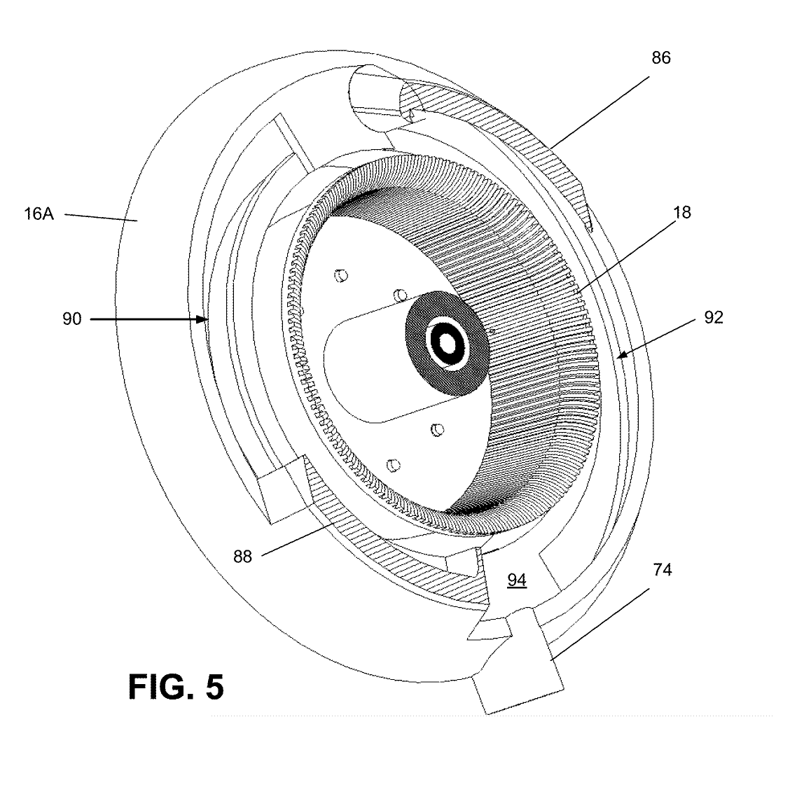

Referring now to FIG. 5, shown is another embodiment of a directional shroud, denoted as directional shroud 16A. In this example embodiment, the directional shroud 16A comprises plural arcs 86 and 88 that block the circular fluid spray dispersed from the lip 18 of the cone 14. It should be appreciated that the quantity of arcs may be greater in some embodiments. Apertures 90 and 92 allow the fluid to pass the directional shroud 16A, whereas the arcs 86 and 88 block the circular spray in a manner similar to that described above, with the blocked fluid flowing in channels located at the bottom of the directional shroud 16A, such as a channel 94, and to a reservoir via the drain 74. Similar to the structure described above, each of the arcs 86 and 88 comprise a leading and trailing edge, though some embodiments may omit such configurations or use only for select arcs.

Although the directional shrouds 16 and 16A are shown with fixed configurations, in some embodiments, a plurality of moveable arcs may be disposed on a rail running circumferentially on or within the directional shroud and positioned manually, or via automated control (e.g., a motor, gear assembly, etc.). For instance, selection of one or a plurality of arcs for a given spray configuration may be achieved through such a control mechanism responsive to feedback of crop or ground topology profiles from one or more sensors coupled to the agricultural machine (e.g., sprayer) as the machine traverses the field. In some embodiments, a map of the crop profile for a given region (e.g., height of the crops, stage of maturity, etc.) may be generated before machine traversal of the field (e.g., based on a previous traversal or other manner of sensing to create the map) and used by a computer system on the agricultural machine to activate a given configuration of arcs (and/or nozzle orientation) for a directional shroud to enable directed spraying based on the profile.

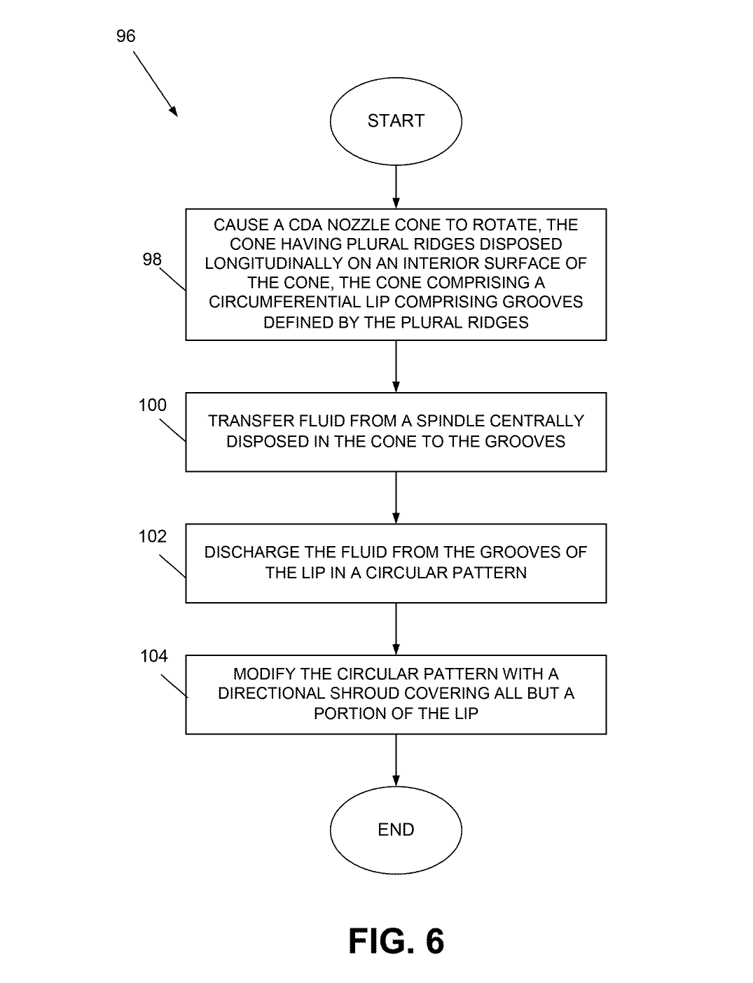

Having described certain embodiments of a CDA system 10, it should be appreciated within the context of the present disclosure that one embodiment of a CDA method (e.g., as implemented in one embodiment by the CDA system 10, though not limited to the specific structures shown in FIGS. 1A-5), denoted as method 96 and illustrated in FIG. 6, comprises causing a CDA nozzle cone to rotate, the cone having plural ridges disposed longitudinally on an interior surface of the cone, the cone comprising a circumferential lip comprising grooves defined by the plural ridges (98); transferring fluid from a spindle centrally disposed in the cone to the grooves (100); discharging (e.g., dispersing, dispensing, etc.) the fluid from the grooves of the lip in a circular pattern (102); and modifying the circular pattern with a directional shroud covering all but a portion of the lip (104). For instance, the modification may be achieved by blocking with one or a plurality of arcs of the shroud the circular spray pattern to provide a truncated spray pattern or patterns.

Any process descriptions or blocks in flow diagrams should be understood as merely illustrative of steps performed in a process implemented by a CDA system, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A controlled droplet application (CDA) system, comprising:
a frame;
a CDA nozzle coupled to the frame, the CDA nozzle comprising:
a cone having plural ridges disposed longitudinally on an interior surface of the cone, the cone comprising a circumferential, outward-directed lip comprising grooves defined by the plural ridges; and
a directional shroud coupled to the frame and covering all but a portion of the lip.

2. The CDA system of claim 1, wherein the directional shroud comprises a single arc, the single arc covering all but a single contiguous portion of the lip.

3. The CDA system of claim 2, wherein the single arc comprises a leading edge and a trailing edge, the trailing edge comprising a hook configuration, the hook directed inward toward a center axis of the cone.

4. The CDA system of claim 1, wherein the directional shroud comprises plural arcs, the plural arcs covering all but the portion.

5. The CDA system of claim 4, wherein the portion comprises plural discontiguous sub-portions of the lip.

6. The CDA system of claim 4, wherein the portion comprises plural contiguous sub-portions of the lip.

7. The CDA system of claim 4, wherein the plural arcs each comprise a leading edge and a trailing edge, the trailing edge comprising a hook configuration, the hook directed inward toward a center axis of the cone.

8. The CDA system of claim 1, wherein the CDA nozzle comprises a shaft surrounding a hollow, stationary spindle, the shaft coupled to the cone, the shaft disposed along a center axis of the directional shroud and the cone.

9. The CDA system of claim 8, further comprising a drive system coupled to the shaft, the drive system configured to rotate the shaft and the cone.

10. A controlled droplet application (CDA) method, comprising:
causing a controlled droplet application (CDA) nozzle cone to rotate, the cone having plural ridges disposed longitudinally on an interior surface of the cone, the cone comprising a circumferential lip comprising grooves defined by the plural ridges;
transferring fluid from a spindle centrally disposed in the cone to the grooves;
discharging the fluid from the grooves of the lip in a circular pattern; and
modifying the circular pattern with a directional shroud covering all but a portion of the lip.

11. The method of claim 10, wherein causing comprises a drive system rotating a shaft coupled to the cone.

12. The method of claim 10, wherein causing comprises causing the CDA nozzle cone to rotate around a horizontal axis coincident with a longitudinal axis of the spindle.

13. The method of claim 10, wherein modifying comprises blocking a single arc portion of the circular spray pattern using a single arc of the directional shroud, wherein a remaining arc portion of the circular spray pattern passes beyond the directional shroud and is dispensed on a target.

14. The method of claim 10, wherein modifying comprises blocking a plurality of arc portions of the circular spray pattern using a plurality of arcs of the directional shroud.

15. The method of claim 14, wherein the blocked plurality of arc portions of the circular spray are separated by an arc portion of the circular spray pattern that passes the directional shroud and is dispensed on a target.

16. The method of claim 14, wherein the plurality of arc portions of the circular spray are directly adjacent each other in the spray pattern, wherein a remaining arc portion of the circular spray pattern passes the directional shroud and is dispensed on a target.
